(19) United States
(12) Patent Application Publication
(10) Pub. No.: US 2019/0125600 A1
(43) Pub. Date: May 2, 2019

(54) FOOTREST DEVICE AND SAFETY DEVICE FOR WHEELCHAIR

(71) Applicant: Young Bae YOU, Yangju-si, Gyeonggi-do (KR)

(72) Inventor: Young Bae YOU, Yangju-si, Gyeonggi-do (KR)

(21) Appl. No.: 16/086,607

(22) PCT Filed: Mar. 30, 2017
(86) PCT No.: PCT/KR2017/003518

§ 371 Date: Sep. 20, 2018

(30) Foreign Application Priority Data
Mar. 31, 2016 (KR) 10-2016-0038984
Apr. 14, 2016 (KR) 10-2016-0045567

(51) Int. Cl. A61G 5/12; A61G 5/10

(52) U.S. Cl. CPC A61G 5/128; A61G 5/1005

(57) ABSTRACT

The present invention relates to a footrest device for a wheelchair, and more particularly to a footrest device and safety device for a wheelchair, in which a footrest provided in a lower side of the wheelchair moves up and down in accordance with a weight applied by a foot of a sitting person, thereby preventing a falling accident caused by stepping on the footrest when the sitting person rises from or sits in the wheelchair.

### TECHNICAL FIELD

The present invention relates to a footrest device for a wheelchair, and more particularly to a footrest device and safety device for a wheelchair, in which a footrest provided in a lower side of the wheelchair moves up and down in accordance with a weight applied by a foot of a sitting person, thereby preventing a falling accident caused by stepping on the footrest when the sitting person rises from or sits in the wheelchair.

### BACKGROUND ART

In general, a wheelchair refers to a means for transportation, in which a patient who is indisposed sits, and is pushed to move by the patient him/herself or by a guardian from behind.

Since the wheelchair is used for a patient who is unwell, it is very dangerous when the patient sits in or rises from the wheelchair. In particular, a footrest, on which the patient puts a foot while sitting in the wheelchair, is used as a means for assisting the patient in sitting in or rising from the wheelchair, and therefore the wheelchair is likely to be turned over or slip over when the patient steps on a footrest device, thereby frequently causing a falling accident that the patient falls on a floor.

Such a falling accident caused by the footrest device is because the footrest device does not have a structure for flexibly absorbing the weight of the patient and thus the patient loses his/her balance and falls as the wheelchair moves or is turned over at the moment when the weight of the patient is put on the footrest device.

### DISCLOSURE

### Technical Problem

Accordingly, the present invention is conceived to solve the foregoing problems, and an aspect of the present invention is to provide a footrest device for a wheelchair, which is configured to move up and down in accordance with a weight applied to the footrest device when a sitting person steps on the footrest device to sit in or rise from the wheelchair, thereby preventing a falling accident caused by stepping on the footrest device when the sitting person rises from or sits in the wheelchair.

An aspect of the present invention is to provide a safety device for a wheelchair, in which a footrest device is configured to move up and down in accordance with a weight applied to the footrest device when a sitting person steps on the footrest device to sit in the wheelchair or steps on the footrest to rise from the wheelchair, and the footrest device is prevented from moving up and down and being locked when the seatbelt is fastened or the brake is unlocked so that the footrest device can safely support the foot of the sitting person while the sitting person is sitting in the wheelchair, but allowed to move up and down only when the sitting person rises from or sits in the wheelchair like a case of releasing the seatbelt or locking the brake, thereby preventing a falling accident caused by stepping on the footrest to sit in or rise from the wheelchair.

### Technical Solution

In accordance with an embodiment of the present invention, there is provided a footrest device for a wheelchair, including: an up/down moving unit which moves down when a preset weight is applied, and moves up when the preset weight is removed; and a footrest which is integrally coupled to the up/down moving unit and moves up and down in accordance with operations of the up/down moving unit.

The up/down moving unit may have an electromotive or mechanical operation to move down when a preset weight is applied, and move up when the weight is removed. The up/down moving unit may include: a main shaft; an up/down moving body coupled to the main shaft and swiveling with respect to the main shaft; a fastening unit having a first end fastened to the up/down moving body and movable relative to the up/down moving body to move down when a preset weight is applied and move up the weight is removed; and an up/down moving member having a first end coupled to the fastening unit and moving together with the fastening unit as the fastening unit moves up and down, and a second end coupled as a single body to the footrest.

The fastening unit may include: a fastening pin coupled to the up/down moving body; a fastening bar having a first end coupled to the fastening pin and a second end coupled to the up/down moving member; and an elastic member having a first end coupled to the up/down moving body and a second end coupled to the fastening bar.

The fastening unit may include a fastening pin coupled to the up/down moving body; a fastening bar having a first end coupled to the fastening pin and a second end coupled to the up/down moving member; and an elastic member having a first end coupled to the up/down moving body and a second end coupled to the up/down moving member.

The elastic member may include an elastic body, an elastic coefficient (K) of which is adjustable, and is designed to have an elastic coefficient to be elastically deformed in accordance with a preset weight of a foot.

The footrest device for the wheelchair according to claim 6, wherein the elastic coefficient is determined by setting the weight of the foot within a range from 5 to 15 kg, applied when the foot is put on the footrest.

In accordance with another embodiment of the present invention, there is provided a safety device for a wheelchair, including: an up/down moving controller which determines a locking mode or up/down moving mode of an up/down moving unit; and an up/down moving unit which moves down when a weight is applied, and moves up when the weight is removed in a case where the up/down moving controller is in the up/down moving mode; and a footrest which is integrally coupled to the up/down moving unit and moves up and down in accordance with operations of the up/down moving unit.

The up/down moving unit may have an electromotive or mechanical operation to move down when a preset weight is applied, and move up when the weight is removed.

The up/down moving unit may include: a main shaft; an up/down moving body coupled to the main shaft and swiveling with respect to the main shaft; a fastening unit having a first end fastened to the up/down moving body and movable relative to the up/down moving body to move down when a preset weight is applied and move up the weight is removed; and an up/down moving member having a first end coupled to the fastening unit and moving together with the fastening unit as the fastening unit moves up and down, and a second end coupled as a single body to the footrest.

The fastening unit may include: a fastening pin coupled to the up/down moving body; a fastening bar having a first end coupled to the fastening pin and a second end coupled to the up/down moving member; and an elastic member having a first end coupled to the up/down moving body and a second end coupled to the up/down moving member.

The up/down moving controller may be constituted by a wheelchair brake unit; have a structure in which the wheelchair brake is coupled to the footrest by a connection member, and the connection member has a structure for pushing or pulling the footrest depending on the change of the tension of the wheelchair brake; perform control so that the connection member has tension of pulling the up/down moving unit of the footrest device, the up/down moving unit of the footrest device moves up by the pulling force, and the footrest enters an up/down moving mode to be movable up and down, when the wheelchair brake is locked; and perform control so that the connection member connected to the wheelchair brake has initial pushing force by the removal of the pulling force to push the up/down moving unit of the footrest device, and the footrest moves down to the lowest position by the pushing force and enters a locking mode to be not movable up and down, when the wheelchair brake is released.

The wheelchair brake unit may include a lever, a brake moving as coupled to the lever by a multi-step joint, and a switch member coupled to the up/down moving unit; perform control so that the brake bar is pulled to press a wheel of the wheelchair and is in a locked state, and the connection member also has pulling force to make the switch member be separated from the up/down moving unit and enter an up/down moving mode, when the lever is lifted up; and perform control so that the brake returns to an original position and is in a released state, and the connection member is also switched over from the pulling tension to pushing force to make the switch member be coupled to the up/down moving unit and enter a locking mode when the lever is lifted down to an original position.

The safety device for the wheelchair may further including a safety bar connected to the wheelchair brake; wherein the safety bar unit and the wheelchair brake are connected by a second connection member extended from the connection member connected between the up/down moving unit of the footrest device and the wheelcair brake; wherein the brake is in a locked state and the footrest operates in a locking mode as the lever of the wheelchair brake is pulled when the safety bar is unlocked; and wherein the brake is in a released state and the footrest operates in an up/down moving mode as the level of the wheelchair brake moves down when the safety bar is locked.

The second connection member may include two second sub connection members extended from two connection members; and a second main connection member formed by combining and extending two sub connection members as one and connected to the safety bar, wherein the second main connection member is coupled to the safety bar so that tension is varied depending on operations of the safety bar; wherein, when the safety bar is unlocked, force of pulling the second main connection member due to the change of the tension is generated to pull the lever of the wheelchair brake connected as a single body, and the up/down moving unit of the footrest device is also pulled to make the footrest enter a up/down moving mode to be movable up and down; wherein, when the safety bar is locked, the second main connection member has pushing force by the removal of the pulling force and can push down the lever of the wheelchair brake connected as a single body, and the up/down moving unit of the footrest device is also pushed to make the footrest enter a locking mode to be immovable.

### ADVANTAGEOUS EFFECTS

The footrest device for the wheelchair according to the present invention has an outstanding effect on preventing a falling accident caused while a patient is rising from or sitting in the wheelchair, since the footrest moves up and down in accordance with a weight of a foot when the patient puts the foot on the footrest to rise from or sit in the wheelchair, so that the patient can safely rise from or sit in the wheelchair while the wheelchair is prevented from moving or being turned over.

Further, the safety device for the wheelchair according to the present invention has an outstanding effect on preventing a falling accident caused while a patient is rising from or sitting in the wheelchair, since the wheelchair is maintained to have the released brake and the footrest is maintained to have the locking mode not to move up and down while the wheelchair is moving, but the brake of the wheelchair is switched over to the locked state and the footrest is switched over to the up/down moving mode to be movable up and down while the wheelchair is stopped for making the patient rise from or sit in the wheelchair, so that the footrest can move up and down in accordance with the weight of the foot without moving the wheelchair when the patient puts the foot on the footrest to rise from or sit in the wheelchair, thereby allowing the patient to safely rise from or sit in the wheelchair while preventing the wheelchair from moving and being turned over

### DESCRIPTION OF DRAWINGS

FIG. 1 is a configuration view schematically illustrating a wheelchair with a footrest device according to an exemplary embodiment of the present invention, and

FIG. 2 is a cross-sectional view schematically illustrating a footrest device according to an exemplary embodiment of the present invention.

FIG. 3 is a view schematically illustrating that a footrest of the footrest device in FIG. 2 moves down and up, showing detailed configurations and operations of a fastening unit of FIG. 2.

FIG. 4 is a view schematically illustrating that a footrest device according to another embodiment of the present invention moves down and up, and FIG. 5 is a view illustrating detailed configurations and operations of a fastening unit of FIG. 4.

FIG. 6 schematically illustrates a footrest device according to still another embodiment of the present invention, schematically showing that the footrest device moves up and down.

FIGS. 7 and 8 are conceptual views schematically illustrating that a mode is determined by a wheelchair brake.

FIG. 9 schematically illustrates that the footrest is switched over between an up/down moving mode and a locking mode in accordance with operations of coupling a switch member of a wheelchair brake unit and a switch coupler of an up/down moving unit according to an exemplary embodiment of the present invention.

FIGS. 10 and 11 schematically illustrate a wheelchair with a safety bar according to the present invention.

FIGS. 12 to 14 are conceptual views schematically illustrating that a mode is determined by the safety bar in the wheelchair.

### BEST MODE

A footrest device for a wheelchair according to the present invention includes an up/down moving unit which moves down when a preset weight is applied, and moves up when the preset weight is removed; and a footrest which is integrally coupled to the up/down moving unit and moves up and down in accordance with operations of the up/down moving unit.

A safety device for a wheelchair according to the present invention includes an up/down moving controller which determines a locking mode or up/down moving mode of an up/down moving unit; and an up/down moving unit which moves down when a weight is applied, and moves up when the weight is removed in a case where the up/down moving controller is in the up/down moving mode; and a footrest which is integrally coupled to the up/down moving unit and moves up and down in accordance with operations of the up/down moving unit.

### Modes of the Invention

Below, embodiments of the present invention will be described in detail with reference to accompanying drawings.

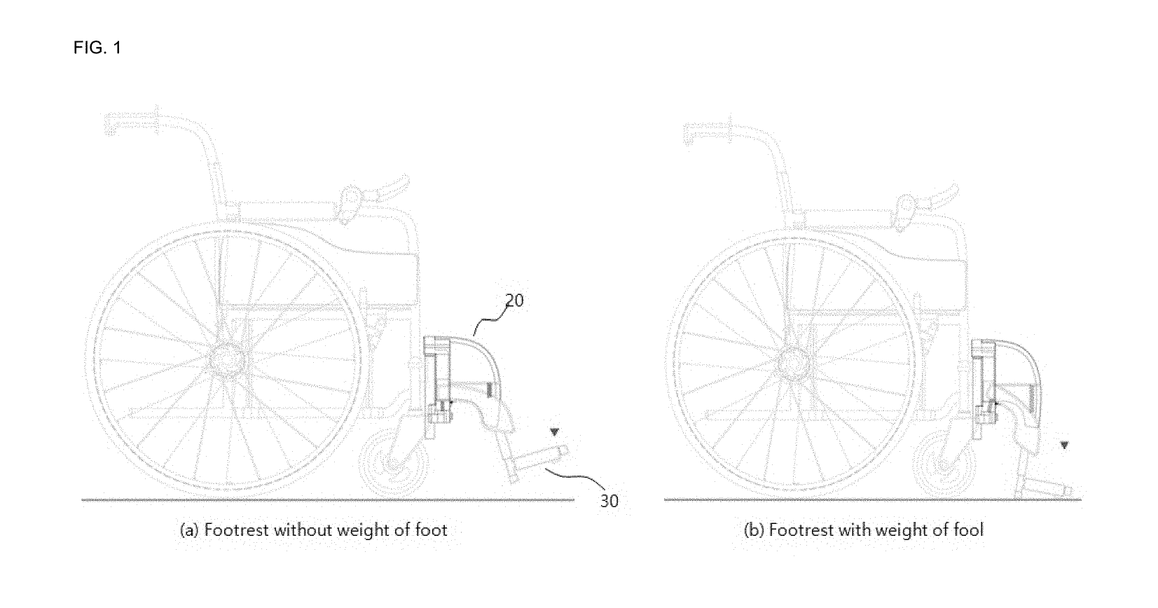

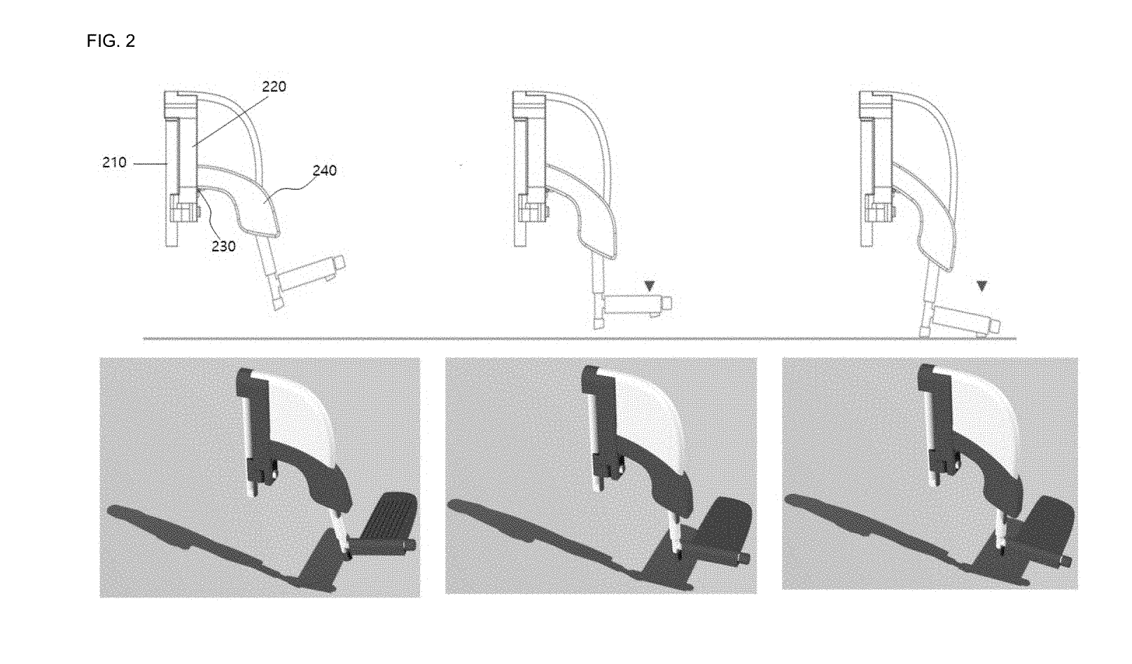

FIG. 1 is a configuration view schematically illustrating a wheelchair with a footrest device according to an exemplary embodiment of the present invention, and FIG. 2 is an elevation view schematically illustrating a footrest device according to an exemplary embodiment of the present invention.

Referring to FIGS. 1 and 2, the footrest device for the wheelchair according to the present invention may include an up/down moving unit 10 which moves down when a preset weight is applied and moves up when the weight is removed; and a footrest 20 which is coupled to the up/down moving unit 10 and moves up and down in accordance with operations of the up/down moving unit 10.

The up/down moving unit 10 moves down by a weight of a foot applied when a patient steps on a footrest 20 to rise from or sit in the wheelchair, and moves up to an original position when the foot is taken off the footrest 20.

Therefore, it is possible to prevent a falling accident that may occur when the wheelchair moves or turns over as a patient puts a foot on the footrest.

The up/down moving unit may have an electromotive or mechanical configuration to move down when a preset weight is applied, and move up when the weight is removed.

The electromotive configuration may include a pressure sensor for sensing a weight, and a motor and a gear assembly for moving the footrest down when the weight sensed by the pressure sensor reaches a preset foot weight, and moving the footrest up to an original position when the pressure sensor senses no weights.

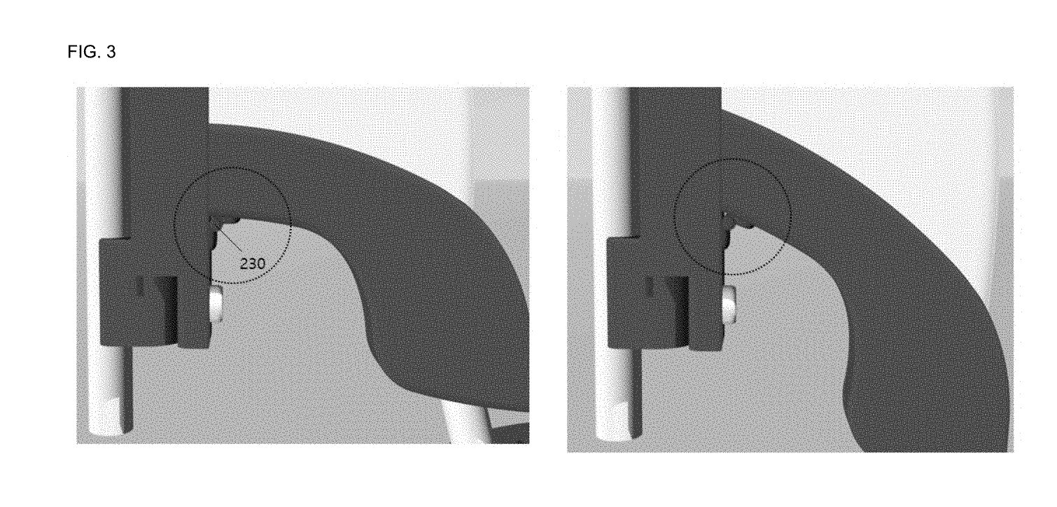

FIG. 3 is a view schematically illustrating that the footrest of the footrest device in FIG. 2 moves down and up, showing detailed configurations and operations of a fastening unit of FIG. 2.

Referring to FIG. 3, the up/down moving unit includes a main shaft 110; an up/down moving body 120 coupled to the main shaft 110 and swiveling with respect to the main shaft 110; a fastening unit 130 having a first end fastened to the up/down moving body 120 and movable relative to the up/down moving body 120 to move down when a preset weight is applied and move up the weight is removed; and an up/down moving member 140 having a first end coupled to the fastening unit 130 and moving together with the fastening unit 130 as the fastening unit 130 moves up and down, and a second end coupled as a single body to the footrest 20.

The up/down moving body 120 may include a shaft member coupled to the main shaft 110 and swiveling with respect to the main shaft 110, and an arc-shaped guide member, and the up/down moving member 140 may be inserted in a groove formed in the shaft member and move up and down along an outside of the guide member.

Here, the up/down moving member 140 has a first end movably inserted in the up/down moving body 140 and coupled to the fastening unit 130 so as to move down relative to the up/down moving body 120 and return to the original position.

Further, the fastening unit 130 may be elastically coupled between the up/down moving body 120 and the up/down moving member 140 by an elastic member, in which the elastic member may be a hinge spring movable up and down while swiveling.

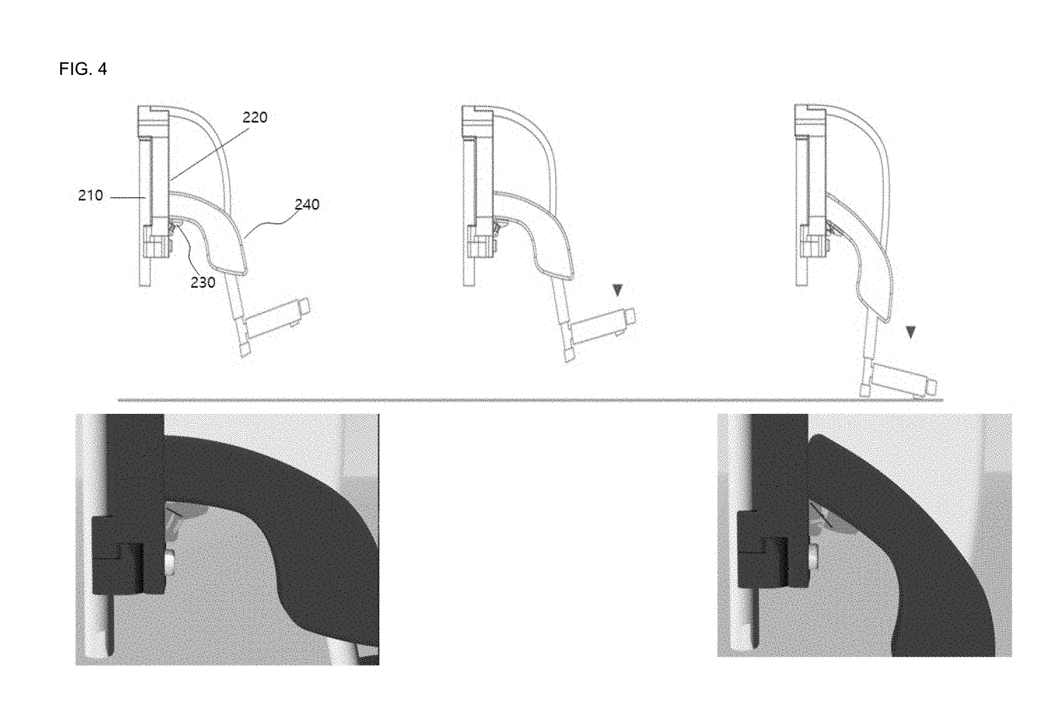

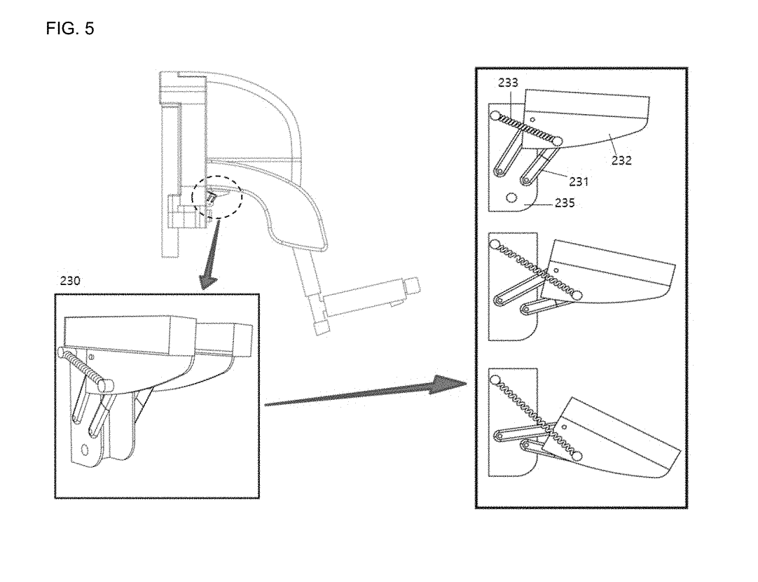

FIG. 4 is a view schematically illustrating that a footrest device according to another embodiment of the present invention moves down and up, and FIG. 5 is a view illustrating detailed configurations and operations of a fastening unit of FIG. 4.

Referring to FIGS. 4 and 5, the fastening unit 130 may include a fastening pin 131 coupled to the up/down moving body 120; a fastening bar 132 having a first end coupled to the fastening pin 131 and a second end coupled to the up/down moving member 140; and an elastic member 133 having a first end coupled to the up/down moving body 120 and a second end coupled to the fastening bar 132.

The fastening pin 131 may be not only directly coupled to the up/down moving body 120, but also coupled to the up/down moving body 120 via a separate fastening piece 135 as shown in FIG. 4.

The fastening unit 130 moves down in response to a weight when a patient puts his/her foot on the footrest, and the up/down moving member 140 coupled to the fastening unit 130 also moves down as the fastening unit 130 moves down, thereby making the footrest 20 move down. Therefore, a patient can rise from or sit in the wheelchair safely without falling out of or falling from the wheelchair.

On the other hand, when a patient takes the foot off the footrest 20, the fastening unit 130 moves up to its original position, and thus the up/down moving member 140 and the footrest 20 also move up to their original positions.

Here, the elastic member 133 is achieved by an elastic body, an elastic coefficient (K) of which is adjustable, and thus designed to have an elastic coefficient to be elastically deformed in accordance with a preset weight of a foot.

The elastic body may be materialized by a spring having elastic force and restoring force.

According to the preset invention, the footrest moves down when a patient puts a foot on the footrest. Therefore, the footrest is configured to move down based on the weight applied by the foot of the patient.

In general, a weight, which is applied when a patient puts a foot on the footrest to rise from or sit in the wheelchair, is varied depending on the weights and ages of the patient. Mostly, the weight ranges from 5 to 15 kg.

Accordingly, the weight of the foot may be set within this range, and the elastic body may be designed to have an elastic coefficient (K) at which initial elastic deformation occurs by the set weight of the foot.

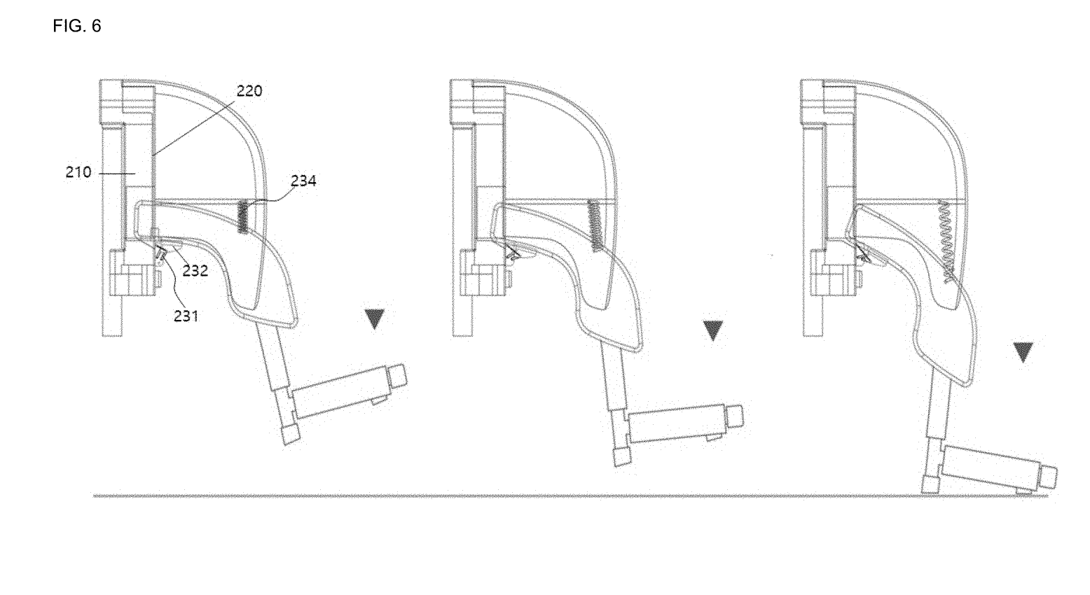

FIG. 6 schematically illustrates a footrest device according to still another embodiment of the present invention, schematically showing that the footrest device moves up and down.

Referring to FIG. 6, the footrest device according to the present invention may include an elastic member of a fastening unit, which is positioned not between the up/down moving body 120 and the fastening bar 132, but between the up/down moving body 120 and the up/down moving member 140.

More specifically, an elastic member 134 may be coupled between an upper portion of the up/down moving member 140 and the up/down moving body 120 and thus provided at a position different from the position where the fastening bar 132 and the fastening pin 131 are provided.

In addition, it will be apparent that the elastic member may be positioned anywhere as long as it can provide elastic force and restoring force to return the up/down moving member moved down by the weight of the foot to the original position when the weight is removed.

Below, a method of operating a footrest device for a wheelchair will be described according to an exemplary embodiment of the present invention.

First, when a patient puts a foot with a weight on the footrest to rise from or sit in the wheelchair.

In general, a patient who wants to sit in the wheelchair steps on a footrest while putting a hand on the wheelchair. Conventionally, the footrest and the wheelchair have been formed as a single body, and therefore a wheel of the wheelchair may be lifted up or the wheelchair may move when the weight is applied to the footrest. In a severe case, the wheelchair may be turned over.

On the other hand, the footrest device according to the present invention allows only the footrest to move down separately from the wheelchair to thereby prevent the wheelchair from moving or being turned over when a patient puts a foot with a weight on the footrest. In addition, the footrest is movable until it contacts a floor, so that a patient can stably sit in or rise from the wheelchair.

Since the footrest according to the present invention is designed to operate by the preset weight of the foot, the footrest does not move down when the foot is just put thereon, but moves down as the initial elastic deformation of the elastic member occurs when a weight of the foot reaches the preset weight.

Subsequently, when the patient completely rises from or sits in the wheelchair and thus takes the foot off the footrest or removes the weight applied to the foot, the elastic member is returned to its original position by not the elastic force but the restoring force and the footrest also moves up to its original position.

Meanwhile, the up/down moving controller 10 may be embodied in two ways of using the wheelchair brake and using the wheelchair brake interworking with the safety bar to determine a mode.

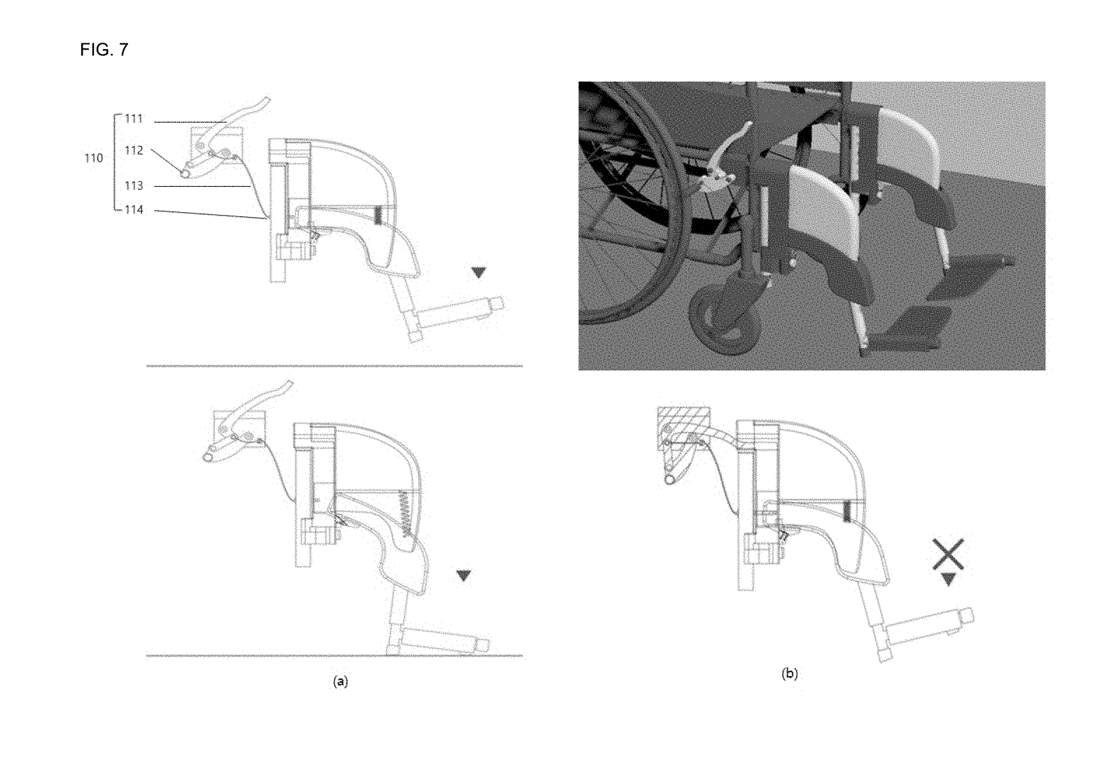

First, the method of determining the mode by the wheelchair brake is as follows. FIG. 7 is a conceptual view schematically illustrating that the mode is determined by the wheelchair brake.

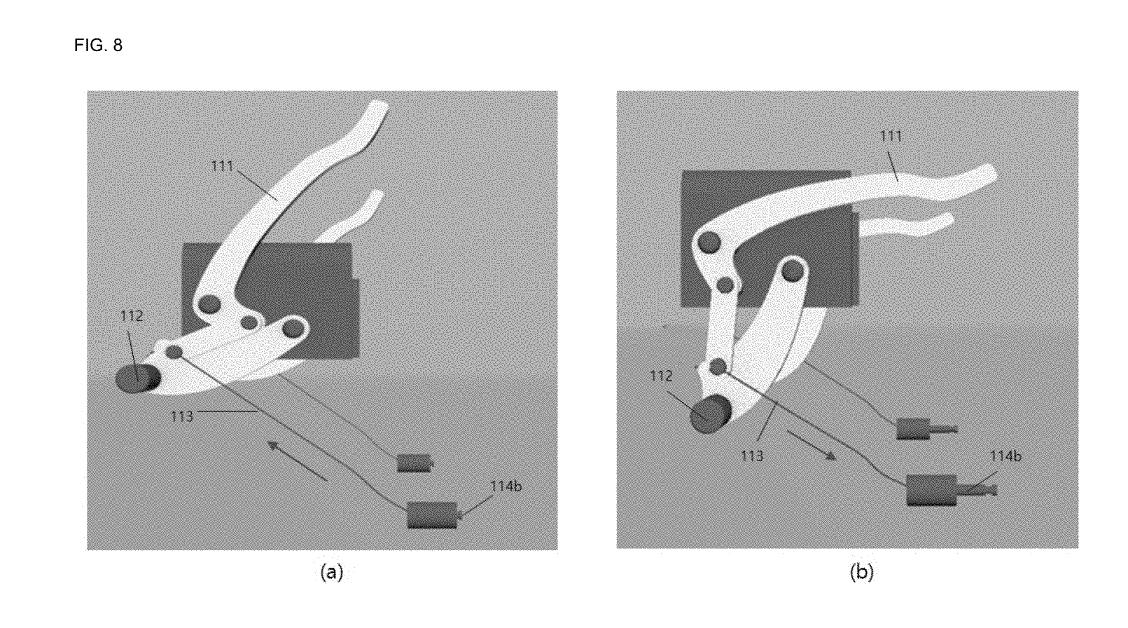

Referring to FIGS. 7 and 8, the up/down moving controller 10 consists of a wheelchair brake unit 110 and a switch member 114 provided at the end of a connection member of the wheelchair brake unit 110 is coupled to the up/down moving unit of the footrest and moves forward and backward under control of the wheelchair brake to thereby switch over the operation of the up/down moving unit 10

between an up/down moving mode and a locking mode.

In more detail, the wheelchair brake unit 110 may include a lever 111 for selecting lock or release of a brake 112; the brake 112 connected to the lever 111 and making the wheel switch over between a lock state and a movable state as the lever 111 operates; a connection member 113 connected to the brake 112 and generating pushing force or pulling force depending on the operation the brake 112; and a switch member 114 provided at the end of the connection member 113, controlling the up/down moving unit 20 enter the locking mode as coupled to a switch coupler 241 provided in the up/down moving member of the up/down moving unit 20 in accordance with change in the tension of the connection member 113, and controlling the up/down moving unit 20 enter the up/down moving mode as separated from the switch coupler 241.

Here, the brake unit 110 may be formed so that the lever 111 and the brake 112 can be coupled by a multi-step joint and have a relative moving trace.

More specifically, when the lever 111 is lifted up, the brake 112 is pulled to press the wheel of the wheelchair and enters a lock state, and at this time the connection member 113 also has the pulling force by the change of the tension.

On the other hand, when the lever 111 is lifted down to its original position, the brake 112 returns to original position and enters a release state, and the connection member 113 is also switched over from the pulling to the pushing force due to the removal of the pulling force

Here, the connection member 113 may be set to initially have the pushing force by initial tension control when the brake 112 is in the release state, and return to its original position by the initial tension when the brake 112 is switched over from the lock state to the release state.

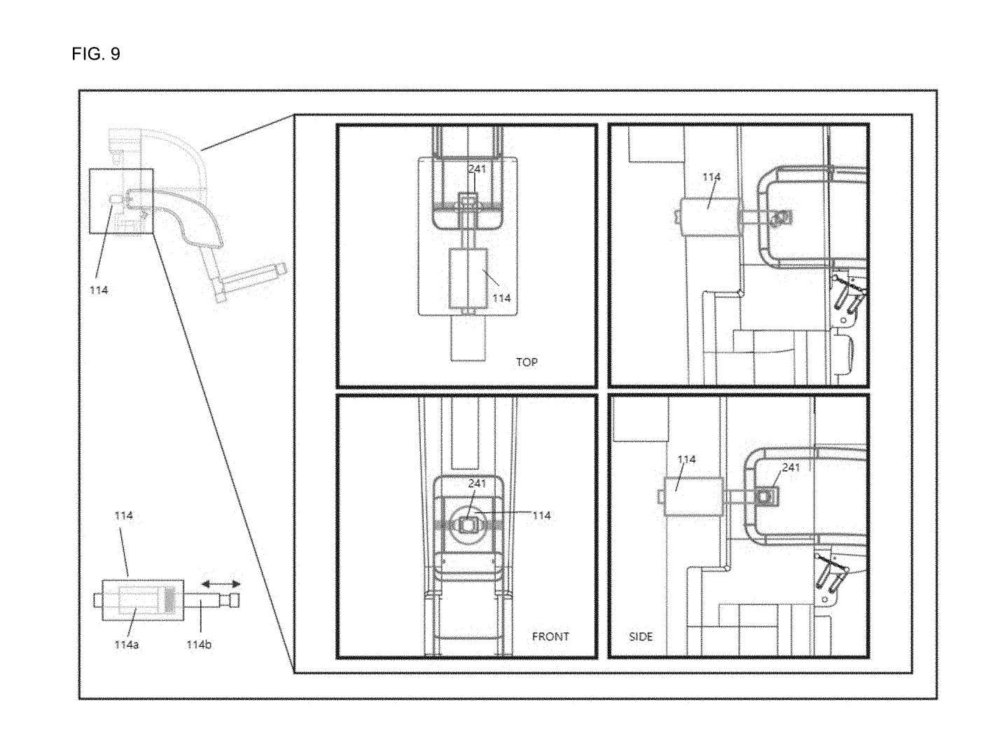

FIG. 9 schematically illustrates that the footrest is switched over between an up/down moving mode and a locking mode in accordance with operations of coupling a switch member of a wheelchair brake unit and a switch coupler of an up/down moving unit according to an exemplary embodiment of the present invention.

Referring to FIG. 9, the switch member 114 of the wheelchair brake unit is inserted in the switch coupler 241 of the up/down moving member by the pushing force of the connection member 113, and separated from the switch coupler 241 by the pulling force of the connection member 113.

The switch member 114 may have a structure in which an elastic guide 114a is formed inside an external frame and a switch bar 114b is movable forward and backward by tension along the elastic guide 114a. In the state that the external frame of the switch member 114 is fastened to the up/down moving member, the switch bar 114b may be inserted in and separated from the external frame in accordance with tension changes.

Here, in the state that the switch bar 114b of the switch member 114 is inserted in the switch coupler 241, the up/down moving unit is locked so that the footrest can be in the locking mode. On the other hand, in the state that the switch member 114b is separated from the switch coupler 241, the up/down moving unit is released so that the footrest can be switched over to the up/down moving mode.

The switch coupler 241 may include an insertion groove for inserting the switch member 114 therein, and an elastic stopper for holding the switch ember 114 when the switch member 114 is inserted in the insertion groove.

Therefore, the switch member 114 is maintained as inserted in the switch coupler 241 by the elasticity of the elastic stopper the when the switch member is inserted, and easily separated from the switch coupler 241 by the pulling force of the switch member 114.

The following <Table 1> shows a relationship in which the mode of the footrest is switched by the operations of the brake.

TABLE 1

| | | | |
|---|---|---|---|
| Brake | Connection | Switch member | Footrest (up/down |
| (lever) | member | | moving unit) |
| Lock | Pulling force | Separated from | Up/down moving |
| | | switch coupler | mode |
| Release | Pushing force | Inserted in switch | Locking mode |
| | | coupler | |

Referring to <Table 1>, when the wheelchair brake is locked as shown in FIG. 7, the connection member has the pulling force and thus the switch member is separated from the switch coupler of the up/down moving unit, so that the up/down moving unit of the footrest can move up and down in accordance with a foot weight, thereby making the footrest enter the up/down moving mode.

On the other hand, when the wheelchair brake is released as shown in FIG. 8, the connection member connected to the brake has the pushing force due to the removal of the pulling force and thus the switch member is inserted in and locked to the switch coupler of the up/down moving unit, so that the up/down moving unit of the footrest cannot move up and down as it is locked by the switch member, thereby making the footrest enter the locking mode.

In result, the locked state of the brake allows a sitting person to sit in or rise from the wheelchair in the state that the security is guaranteed as the wheelchair does not move or go. In this state, the footrest is movable up and down by a foot weight of when the sitting person steps on the footrest, so that the sitting person can safely sit in or rise from the wheelchair while the wheelchair is not moving, thereby guaranteeing the safety doubly.

On the other hand, the released state of the brake makes the wheelchair be movable, so that a sitting person who is sitting in the wheelchair can go. In this state, the footrest is prevented from moving, so that a foot can be stably put on the footrest while traveling.

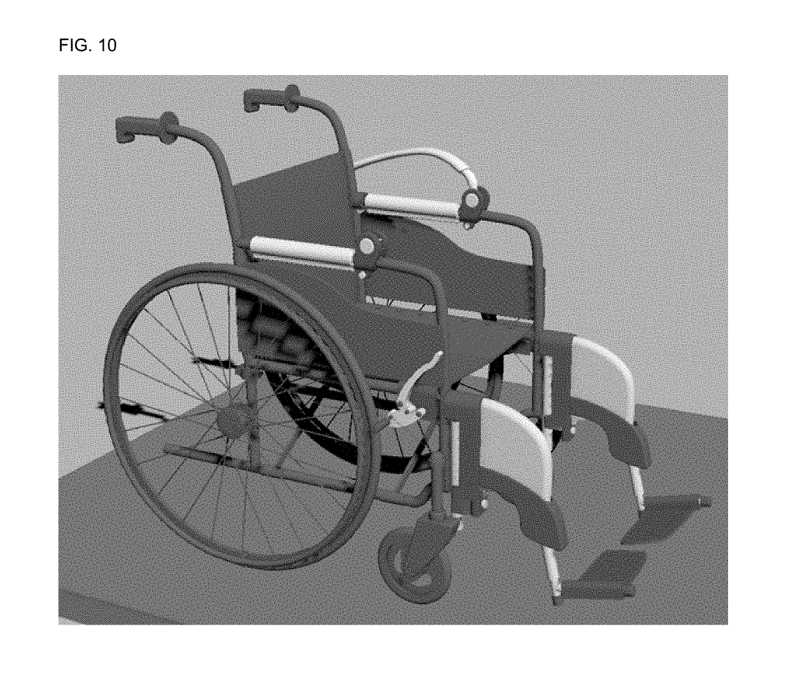

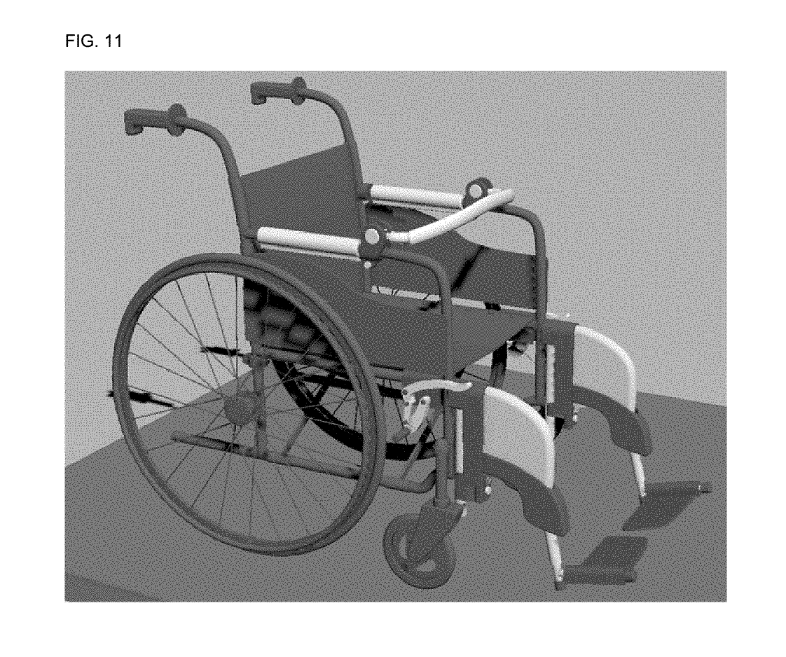

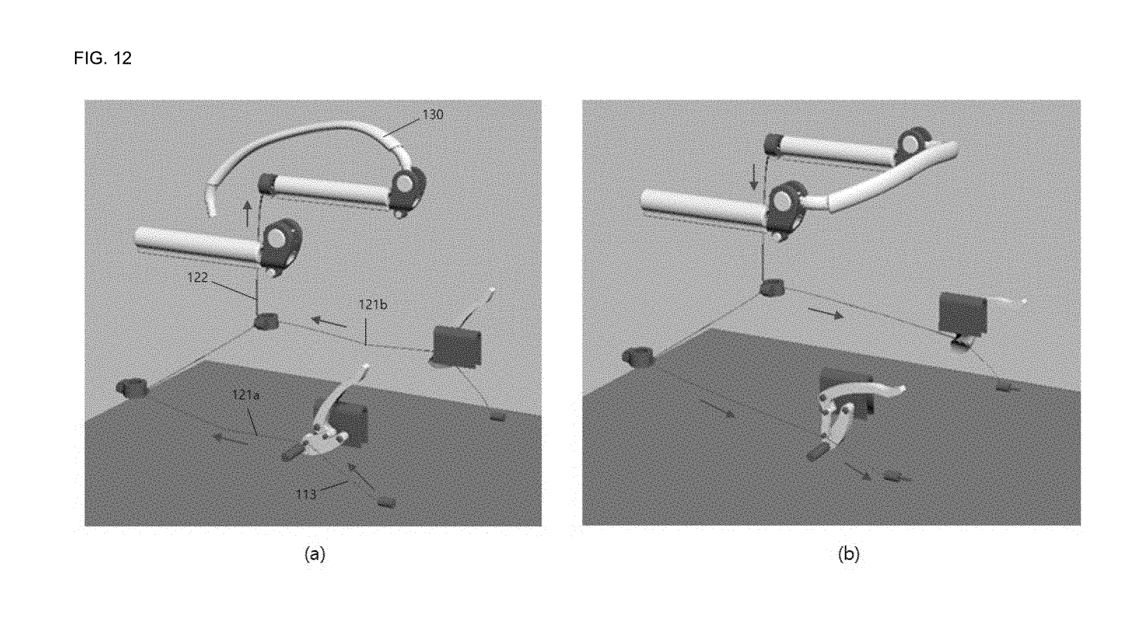

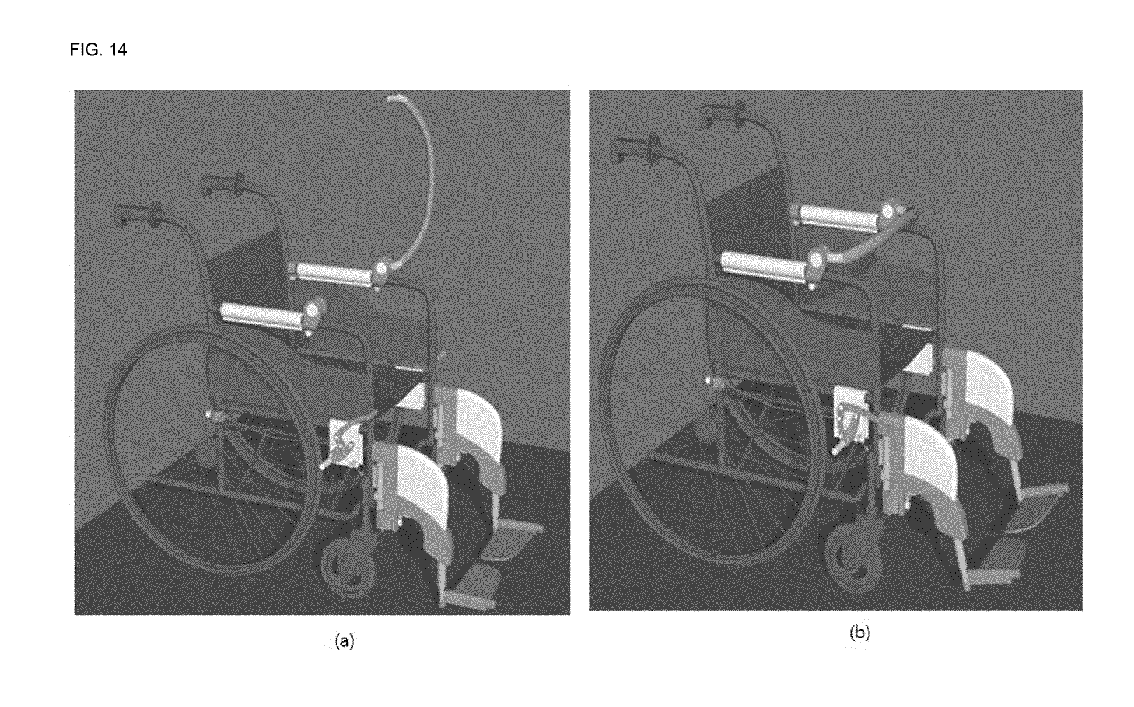

Next, the method of determining the mode by the wheelchair brake interworking with the safety bar is as follows. FIGS. 10 and 11 schematically illustrate a wheelchair with a safety bar according to the present invention, and FIGS. 12 to 14 are conceptual views schematically illustrating that a mode is determined by the wheelchair interworking with the safety bar.

Referring to FIGS. 10 to 14, the method of determining the mode based on the wheelchair interworking with the safety bar is similar to the operating method as shown in FIGS. 7 and 8 except that the embodiment shown in FIGS. 7 and 8 having the structure that the lever of the wheelchair brake is manually pulled up or down but the embodiment of FIGS. 10 and 11 shows a structure that the lever of the brake is automatically pulled up when the safety bar is locked and automatically returns down to its original position when the safety bar is released.

In more detail, a safety bar unit 130 and the wheelchair brake are connected by a second connection member 120 extended in an opposite direction to the connection member 113 connected between the up/down moving unit of the footrest device and the wheelcair brake

Here, the second connection member 120 may include two second sub connection members 121a and 121b extended from two connection members 113, and a second main connection member 122 extended from a junction between two sub connection members 121a and 121b and connected to the safety bar unit 130.

Here, the second connection member 120 and the connection member 113 may be integrally connected to have the same tension, and the second connection member 120 connected to the safety bar unit 130 may be installed as adjusted in tension so as to basically have the pulling force while the safety bar 132 is not locked, thereby switching over to the pushing force while the safety bar 132 of the safety bar unit 130 is locked.

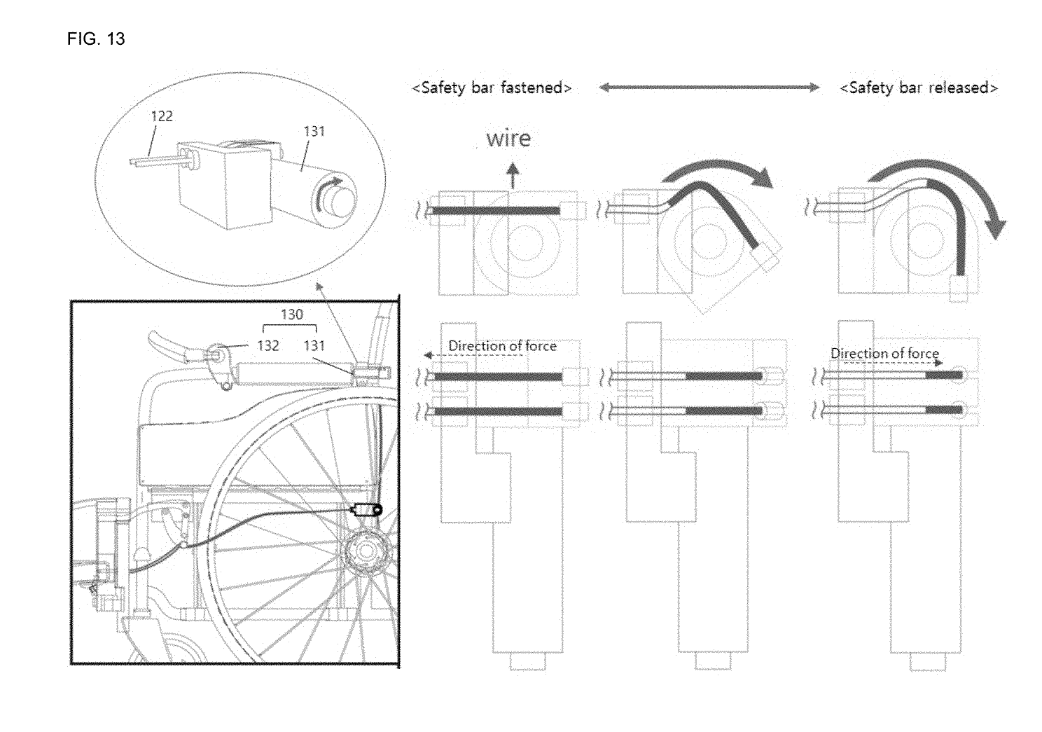

More specifically, as shown in FIG. 13, the safety bar unit 130 may include a tension control member 131 connected to the second main connection member 122 and changing the tension as rotated for locking or releasing the safety bar 132, and the safety bar 132 integrally connected to the tension control member 131

The safety bar 132 has a structure for clockwise or counterclockwise rotation for locking or releasing, and the rotation is transferred to the tension control member 131 so that change in tension can be transferred to the second main connection member 122 connected to the tension control member 131, thereby switching over between the pulling tension and the pushing tension.

Basically, as shown in FIG. 13, the tension control member 131 generates the pushing tension in the state that the safety bar 132 is locked, and the tension control member 131 rotates and switches over to the pulling tension by the restoring force when the safety bar 132 is released. On the other hand, when the safety bar is changed from the released state to the locked state, the pulling tension is switched over to the pushing tension.

The following <Table 2> shows a relationship in which the mode of the footrest is switched by the operations of the safety bar.

TABLE 2

| | | | | | |
|---|---|---|---|---|---|
| Safety bar | Second | Brake | Connection | Switch | Footrest |
| | connection | (lever | member | member | (up/down |
| | member | | | | moving |
| | | | | | unit) |
| Release | Pulling | Lock | Pulling | Separated | Up/down |
| | force | | tension | from switch | moving |
| | | | | coupler | mode |
| Lock | Pushing | Release | Pushing | Inserted in | Locking |
| | force | | tension | switch | mode |
| | | | | coupler | |

The second main connection member is directly connected to the safety bar so that tension can be varied depending on the operations of the safety bar, and set to initially have the pulling force by the control of the tension of the second main connection member.

Referring to <Table 2>, when the safety bar 132 is unlocked as shown in FIG. 12, the second main connection member 122 basically set to have the pulling force pulls the lever 111 of the wheelchair brake connected as a single body, and the up/down moving unit 240 of the footrest device is also pulled, thereby making the footrest 30 enter the up/down moving mode.

On the other hand, when the safety bar 13 is locked as shown in FIG. 13, the second main connection member 122 has the pushing force and pushes down the lever 111 of the wheelchair brake connected as a single body, and the up/down moving unit 240 of the footrest device is also pushed, thereby making the footrest 30 enter the locking and immovable mode.

In result, when the safety bar 132 is locked and thus the wheelchair is movable, the brake is released and the footrest is locked to be not movable, so that a sitting person can move while safely putting his/her foot on the footrest. On the other hand, when the safety bar 132 is released to switch over to a state for rising from or sitting in the wheelchair, the brake is locked and the footrest is switched over to the up/down movable mode, so that the footrest can move up and down bearing the weight of the sitting person while guaranteeing that the wheelchair does not move or go, thereby making the sitting person safely rise from or sit in the wheelchair.

Although a few exemplary embodiments of the present invention have been described with reference to the accompanying drawings, it will be appreciated by those skilled in the art that various changes or modifications can be made in these embodiments without departing from the principles and spirit of the invention, the scope of which is defined in the appended claims and their equivalents.

### INDUSTRIAL APPLICABILITY

The present invention is very useful to wheelchair industry because a footrest provided in a lower side of the wheelchair moves up and down in accordance with a weight applied by a foot of a sitting person, and thus a falling accident caused by stepping on the footrest is prevented when the sitting person rises from or sits in the wheelchair.

1. A footrest device for a wheelchair, comprising:
an up/down moving unit which moves down when a preset weight is applied, and moves up when the preset weight is removed; and
a footrest which is integrally coupled to the up/down moving unit and moves up and down in accordance with operations of the up/down moving unit.

2. The footrest device for the wheelchair according to claim 1, wherein the up/down moving unit has an electromotive or mechanical operation to move down when a preset weight is applied, and move up when the weight is removed.

3. The footrest device for the wheelchair according to claim 1, wherein the up/down moving unit comprises:
a main shaft;
an up/down moving body coupled to the main shaft and swiveling with respect to the main shaft;
a fastening unit having a first end fastened to the up/down moving body and movable relative to the up/down moving body to move down when a preset weight is applied and move up the weight is removed; and
an up/down moving member having a first end coupled to the fastening unit and moving together with the fastening unit as the fastening unit moves up and down, and a second end coupled as a single body to the footrest.

4. The footrest device for the wheelchair according to claim 3, wherein the fastening unit comprises:
a fastening pin coupled to the up/down moving body;
a fastening bar having a first end coupled to the fastening pin and a second end coupled to the up/down moving member; and
an elastic member having a first end coupled to the up/down moving body and a second end coupled to the fastening bar.

5. The footrest device for the wheelchair according to claim 3, wherein the fastening unit comprises:
a fastening pin coupled to the up/down moving body;
a fastening bar having a first end coupled to the fastening pin and a second end coupled to the up/down moving member; and
an elastic member having a first end coupled to the up/down moving body and a second end coupled to the up/down moving member.

6. The footrest device for the wheelchair according to claim 4, wherein the elastic member comprises an elastic body, an elastic coefficient (K) of which is adjustable, and is designed to have an elastic coefficient to be elastically deformed in accordance with a preset weight of a foot.

7. The footrest device for the wheelchair according to claim 6, wherein the elastic coefficient is determined by setting the weight of the foot within a range from 5 to 15 kg, applied when the foot is put on the footrest.

8. A safety device for a wheelchair, comprising:
an up/down moving controller which determines a locking mode or up/down moving mode of an up/down moving unit; and
an up/down moving unit which moves down when a weight is applied, and moves up when the weight is removed in a case where the up/down moving controller is in the up/down moving mode; and
a footrest which is integrally coupled to the up/down moving unit and moves up and down in accordance with operations of the up/down moving unit.

9. The safety device for the wheelchair according to claim 8, wherein the up/down moving unit has an electromotive or mechanical operation to move down when a preset weight is applied, and move up when the weight is removed.

10. The safety device for the wheelchair according to claim 8, wherein the up/down moving unit comprises:
a main shaft;
an up/down moving body coupled to the main shaft and swiveling with respect to the main shaft;
a fastening unit having a first end fastened to the up/down moving body and movable relative to the up/down moving body to move down when a preset weight is applied and move up the weight is removed; and
an up/down moving member having a first end coupled to the fastening unit and moving together with the fastening unit as the fastening unit moves up and down, and a second end coupled as a single body to the footrest.

11. The safety device for the wheelchair according to claim 10, wherein the fastening unit comprises:
a fastening pin coupled to the up/down moving body;
a fastening bar having a first end coupled to the fastening pin and a second end coupled to the up/down moving member; and
an elastic member having a first end coupled to the up/down moving body and a second end coupled to the up/down moving member.

12. The safety device for the wheelchair according to claim 8, wherein
the up/down moving controller comprises a wheelchair brake unit;
has a structure in which the wheelchair brake is coupled to the footrest by a connection member, and the connection member has a structure for pushing or pulling the footrest depending on the change of the tension of the wheelchair brake;
performs control so that the connection member has tension of pulling the up/down moving unit of the footrest device, the up/down moving unit of the footrest device moves up by the pulling force, and the footrest enters an up/down moving mode to be movable up and down, when the wheelchair brake is locked; and
performs control so that the connection member connected to the wheelchair brake has initial pushing force by the removal of the pulling force to push the up/down moving unit of the footrest device, and the footrest moves down to the lowest position by the pushing tension and enters a locking mode to be not movable up and down, when the wheelchair brake is released.

13. The safety device for the wheelchair according to claim 12, wherein the wheelchair brake unit comprises a lever, a brake moving as coupled to the lever by a multi-step joint, and a switch member coupled to the up/down moving unit;
performs control so that the brake bar is pulled to press a wheel of the wheelchair and is in a locked state, and the connection member also has pulling tension to make the switch member be separated from the up/down moving unit and enter an up/down moving mode, when the lever is lifted up; and
performs control so that the brake returns to an original position and is in a released state, and the connection member is also switched over from the pulling tension to pushing tension to make the switch member be coupled to the up/down moving unit and enter a locking mode when the lever is lifted down to an original position.

14. The safety device for the wheelchair according to claim 12, further comprising a safety bar connected to the wheelchair brake;
wherein the safety bar unit and the wheelchair brake are connected by a second connection member extended from the connection member connected between the up/down moving unit of the footrest device and the wheelcair brake;
wherein the brake is in a locked state and the footrest operates in a locking mode as the lever of the wheelchair brake is pulled when the safety bar is unlocked; and
wherein the brake is in a released state and the footrest operates in an up/down moving mode as the level of the wheelchair brake moves down when the safety bar is locked.

15. The safety device for the wheelchair according to claim 14, wherein the second connection member comprises:
two second sub connection members extended from two connection members; and
a second main connection member formed by combining and extending two sub connection members as one and connected to the safety bar,
wherein the second main connection member is coupled to the safety bar so that tension is varied depending on operations of the safety bar;
wherein, when the safety bar is unlocked, force of pulling the second main connection member due to the change of the tension is generated to pull the lever of the wheelchair brake connected as a single body, and the up/down moving unit of the footrest device is also pulled to make the footrest enter a up/down moving mode to be movable up and down; and
wherein, when the safety bar is locked, the second main connection member has pushing force by the removal of the pulling force and pushes down the lever of the wheelchair brake connected as a single body, and the up/down moving unit of the footrest device is also pushed to make the footrest enter a locking mode to be immovable.

16. The footrest device for the wheelchair according to claim 5, wherein the elastic member comprises an elastic body, an elastic coefficient (K) of which is adjustable, and is designed to have an elastic coefficient to be elastically deformed in accordance with a preset weight of a foot.
